(19) United States
(12) Patent Application Publication
(10) Pub. No.: US 2022/0164773 A1
(43) Pub. Date: May 26, 2022

(54) APPARATUS AND TECHNIQUE FOR THE INCREASE OF PROCUREMENT PROCESS EFFICIENCY

(71) Applicant: Saudi Arabian Oil Company, Dhahran (SA)

(72) Inventors: Majed Omar Mohammad Rubaiyan, Dammam (SA); Matthew Edward Barry Stephansson, Dhahran (SA); Abdulrahman Saleh A. Alghamdi, Dammam (SA)

(73) Assignee: Saudi Arabian Oil Company, Dhahran (SA)

(21) Appl. No.: 17/101,602

(22) Filed: Nov. 23, 2020

(51) Int. Cl. G06Q 10/10; G06Q 10/06

(52) U.S. Cl. CPC G06Q 10/103; G06Q 30/08; G06Q 10/0637; G06Q 10/06393

(57) ABSTRACT

Systems and computer-implemented methods herein are related to averaging normalized values related to a first plurality of factors to generate a first value related to documented procedures of a procurement process of a project; averaging normalized values related to a second plurality of factors to generate a second value related to lead time of the procurement process; averaging normalized values related to a third plurality of factors to generate a third value related to performance of the procurement process; determining, based on the first, second, and third values, a fourth value related to efficiency of the procurement process; outputting an indication of the fourth value; and outputting an indication of a remedial action to be taken related to one or more of the first value, the second value, and the third value. Other embodiments may be described or claimed.

### TECHNICAL FIELD

The present disclosure relates to identification and increase of efficiency for procurement activities.

### BACKGROUND

Different projects within a company may have or implement one or more procurement processes to acquire the necessary personnel or materials for the completion of this project.

### SUMMARY

The present disclosure describes computer-implemented methods, computer-readable media and computer systems that implement techniques that can be used for assessing the effectiveness of procurement activities within different projects. Specifically, embodiments of computer-related operations may allow for assessment of the effectiveness of project procurement activities through data analysis and benchmarking, in conjunction with iterative improvement. Generally, the technique may include analysis and benchmarking of three different aspects of a project, which will be referred to herein as a maturity index (MI), a leading indicators index (LI), and a performance index (PI).

The MI may relate to evaluation of processes and guidelines that support successful material procurement on projects. More generally, the MI may refer to documented procedures of the procurement process. The LI may refer to potential areas of risk in the procurement activities of various projects prior to impacting the performance goals of the overall project. More generally, the LI may refer to the lead time for different aspects or activities of the procurement processes. The PI may refer to the performance of individual projects in key areas of material procurement. More specifically, the PI may refer to the performance of different activities or aspects of the procurement process.

In some implementations, a computer-implemented method includes averaging, by one or more processors of an electronic device, normalized values related to a first plurality of factors to generate a first value related to documented procedures of a procurement process of a project. The method further includes averaging, by the one or more processors, normalized values related to a second plurality of factors to generate a second value related to lead time of the procurement process. The method further includes averaging, by the one or more processors, normalized values related to a third plurality of factors to generate a third value related to performance of the procurement process;. The method further includes determining, by the one or more processors based on the first, second, and third values, a fourth value related to efficiency of the procurement process. The method further includes outputting, by the one or more processors, an indication of the fourth value. The method further includes outputting, by the one or more processors, an indication of a remedial action to be taken related to one or more of the first value, the second value, and the third value.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The procurement process may include several separate aspects or activities. An inefficiency or interruption of one or more of the aspects of activities of the procurement process may generate downstream inefficiencies and have a negative impact to the project. Typically, accurate and consistent identification of the efficiency of different areas or aspects of a procurement pipeline may be difficult.

The subject matter described in this specification can be implemented in particular implementations, so as to realize one or more of the following advantages. The subject matter herein may provide a repeatable and consistent tool which may be used to measure the effectiveness of procurement activities of a project. Embodiments may further assist with the identification of risk within the procurement process, and aspects or activities which may be improved. In one embodiment, a suggestion of specific remedial actions which may be taken to mitigate the risk or improve the activity may be provided. Further, embodiments may provide stakeholders with a tool by which the overall health of a project, rather than only a specific aspect of the project, may be evaluated.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1A is a block diagram illustrating an example computer system used to provide computational functionalities associated with described algorithms, methods, functions, processes, flows, and procedures as described in the present disclosure, in accordance with various embodiments of the present disclosure.

FIG. 1B depicts an example technique by which aspects of the MI may be identified and evaluated, in accordance with various embodiments of the present disclosure.

FIG. 2 depicts an example technique by which aspects of the LI may be identified and evaluated, in accordance with various embodiments of the present disclosure.

FIG. 3 depicts an example technique by which aspects of the PI may be identified and evaluated, in accordance with various embodiments of the present disclosure.

FIG. 4 depicts an example technique by which a score related to the efficiency of the procurement process may be identified and evaluated, in accordance with various embodiments of the present disclosure.

FIG. 5 depicts an example output of the analysis of the procurement process, in accordance with various embodiments.

FIG. 6 depicts an alternative example output of the analysis of the procurement process, in accordance with various embodiments.

FIG. 7 depicts an alternative example output of the analysis of the procurement process, in accordance with various embodiments.

Like reference numbers and designations in the various drawings indicate like elements.

### DETAILED DESCRIPTION

The following detailed description describes techniques for evaluating different aspects of a procurement process. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

In some implementations, and as previously described, the present disclosure describes techniques that can be used for assessing the effectiveness of procurement activities within different projects. Specifically, embodiments may allow for assessment of the effectiveness of project procurement activities through data analysis and benchmarking, in conjunction with iterative improvement. Generally, the technique may include analysis and benchmarking the MI, the LI, and the PI.

Typically, assessment of the MI may be at a company or organization level rather than a project-by-project basis. The appropriate level for assessment of the MI may be dependent on the project, the company, or the organization (or department) that is implementing the project. For example, if the project is executed by more than one organization with the company, then separate MI scores may be identified for each organization or department, which may allow the company to assess the implementation of procurement-related processes and procedures for each department or organization. In some embodiments, assessment of the MI may be performed by a specific office or department of an organization or company, for example one which is separate from that which is responsible for the implementation of the project. In another embodiment, assessment of the MI may be automatic and performed by one or more computing devices based on various input data.

By contrast, one or both of the LI and PI may be viewed as project-level components, that is, they may be implemented on a project-by-project basis. In some embodiments, the LI and PI assessments may be the responsibility of the team, organization, or department that is implementing a given project for which the LI and PI are being assessed. In some embodiments, these assessments may be performed automatically, while in another embodiment the assessments may be performed by an individual. In some embodiments, the criteria used for assessment of one or more factors of the MI, LI, and PI may be standardized across an organization, department, project, team, company, etc. This standardization may allow for consistent and repeatable results such that different projects, or different iterations of a project, may be compared to one another. In another embodiment, one or more of the criteria used for assessment of one or more factors of the MI, LI, and PI may be different between different organizations, departments, projects, companies, teams, etc.

As a result of the MI, LI, and PI, one or more summary reports may be prepared and output. The summary report(s) may include one or more of the following:

a result and assessment score for one or more factors of the LI, MI, or PI;

an overall score for the LI, MI, or PI;

one or more notes related to justifications for the score of one or more factors of the LI, MI, or PI;

an overall score for the project under evaluation.

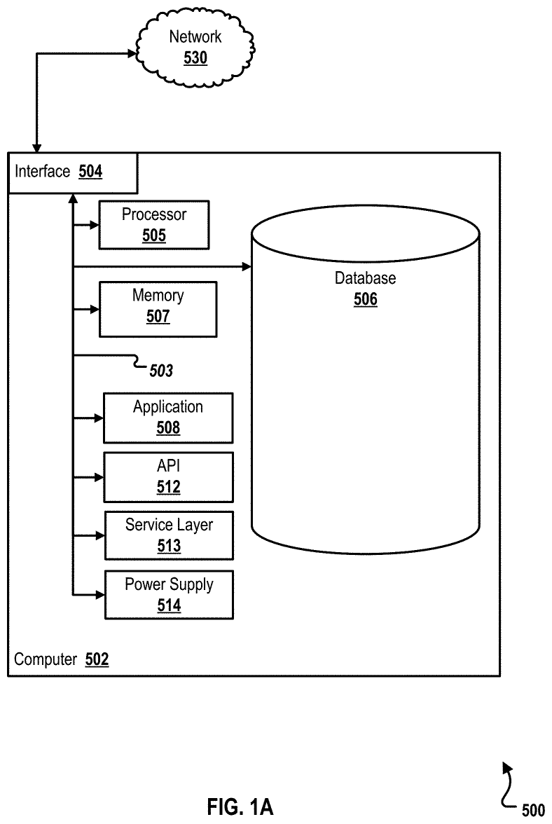

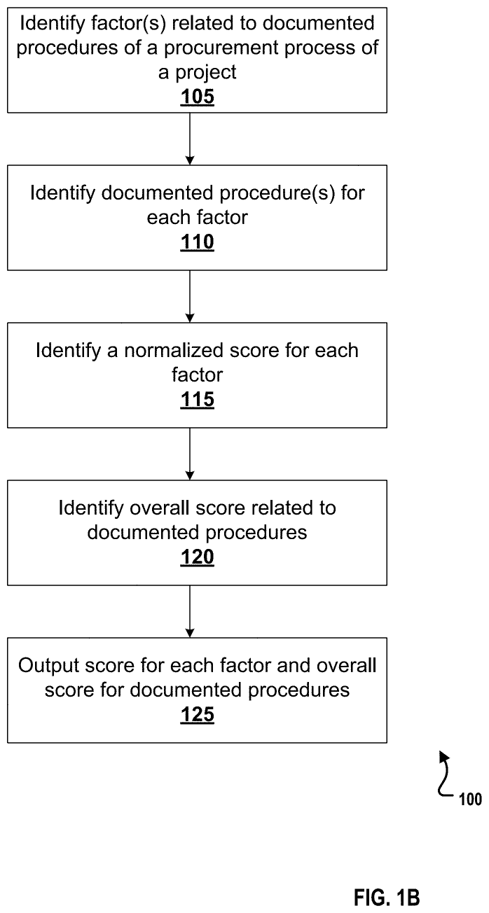

FIGS. 1B, 2, 3, and 4 depict flowcharts of an example of a technique, in accordance with various embodiments herein. For clarity of presentation, the description that follows generally describes the techniques in the context of the other Figures in this description. However, it will be understood that one or more of the techniques of FIGS. 1B, 2, 3, and 4 may be performed, for example, by any suitable system, environment, software, and hardware, or a combination of systems, environments, software, and hardware, as appropriate. In some implementations, various elements of the techniques can be run in parallel, in combination, in loops, or in any order. Additionally, various embodiments may include more or fewer elements than are depicted in FIGS. 1B, 2, 3, or 4.

It will also be understood that, as used herein with respect to FIGS. 1B, 2, 3, or 4, the term “processor” is intended as a general term to refer to a processor, a central processing unit (“CPU”), a core of a multi-core processor, etc. For example, in some embodiments, the processor may be processor 505 of FIG. 1A.

Similarly, various elements of FIGS. 1B, 2, 3, and 4 refer to pre-identified data, processes, techniques or algorithms. These elements may be stored in, for example, database 506 of FIG. 1A, or some other database, table, or storage media, whether transitory or non-transitory.

Specifically, FIG. 1A is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 1A, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 1A, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 1A, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 1A, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

### MI

FIG. 1B depicts an example technique 100 by which aspects of the MI may be identified and evaluated, in accordance with various embodiments of the present disclosure. The technique 100 may include identifying, at 105, one or more factors related to documented procedures of a procurement process of a project. As previously noted, these factors may be on a project-by-project basis, while in other embodiments one or more of the factors may be on a team-level, an organization-level, a company-level, a department-level, etc. Identification of these factors may be performed by one or more processors of one or more electronic devices based on, for example, operator input, pre-identified data (e.g., data input into the system during a configuration setup), data identified during the course of performing the technique 100 (e.g., mining one or more databases), or some other input.

### MI Factors

The factors related to MI may be broadly categorized into factors related to procurement efficiency and effectiveness, workforce maturity, and compliance controls. The procurement efficiency and effectiveness factors may include factors related to the pre-procurement process, the procurement process, and the post-procurement process. The factors related to workforce maturity may include factors related to management, planning, and competency/development. The factors related to compliance controls may include factors related to the bid package or contract terms/conditions.

An example of a pre-procurement process factor is “Purchase Requisition (PR) Development,” which relates to the existence of a documented process to control and manage the development of material purchase requisitions to be handled by internal and external purchasing organizations. Another example is “Bidders List Selection,” which relates to a documented process to control the development of a material specification to allow for maximum bidding participation.

An example of a procurement process factor is “Bid Reviews,” which relates to a documented process to control and manage the project management team's (“PMT's”) activities within the bidding process. This includes the resolution of bid clarifications, technical evaluation, and other activities that would be handled by the PMT regardless of the organization that issued the bid. Another example is “Cost Optimization,” which relates to a documented process to evaluate and clarify bidder proposals to ensure that they not only meet the stated requirements, but do not needlessly exceed it.

An example of a post-procurement process factor is “Change Order Management,” which relates to a documented process to limit the changes to issued purchase orders, and how to control the costs when they are required. The Change Order Management factor may also identify how change orders are reviewed, evaluated, and processed in timely manner to limit the impact material delivery date. Another example is “Expediting,” which relates to a documented process to track the progress of a purchase order against the contractual delivery schedule. The “Expediting” factor may address applicable PMT actions including design approvals, inspection, delivery clearances, etc. that impact the final delivery of material. Another example is “Invoicing,” which relates to a documented process to manage the timely processing of supplier invoices. The “Invoicing” factor may include advance payments, progressive payments and milestones payments. Another example is “Supplier Performance Management,” which relates to a documented process to ensure supplier evaluations are conducted and uploaded into the corporate system, in a comprehensive and effective manner. Another example is “Material Reconciliation,” which relates to a document process to control, handle and manage company-supplied free-issued material. The “Material Reconciliation” factor may identify the steps at various stages of the process, from initial purchase to the identification of surplus material.

An example of a management process factor is “Procurement Management and Organization,” which relates to guidelines or reference material on the required organizational structure of PMT organization handling material procurement administration.

An example of a planning factor is “Continuity and Rotation,” which refers to guidelines or references on how to transfer the ownership of material purchases from one individual or PMT group to another. This guideline or reference material may address both permanent and temporary changes (i.e. vacation coverage). Another example of a planning factor is “Knowledge Transfer,” which refers to a documented process for transferring knowledge from experienced to new employees.

An example of a competency/development factor is “Years of Experience and Certification,” which relates to specific and documented guidelines to distribute the work upon the level of experience and competency. Another example of a competency and development factor is “Training Courses, Events, and Organizational Assignments,” which relates to a standardized development track for personnel handling purchase order administration functions within a PMT.

An example of a bid package factor is “Scope Compliance,” which relates to guidelines or controls to ensure that PMT personnel are fully aware of the scope proposed and agreed with the bidder during bidding. This factor may relate to some or all of the relevant personnel involved in the procurement cycle, including contractors, involved in the review of designs, inspections, transportation, and receipt of material.

An example of a contract terms/conditions factor is “Contract Compliance,” which relates to guidelines or controls to ensure that PMT personnel are fully aware of the purchase order terms and conditions, and the relevant obligation of both the company and the vendor. This factor may relate to some or all relevant personnel involved in the procurement cycle, including contractors, involved in the review of designs, inspections, transportation, and receipt of material.

### MI Scoring

The technique 100 may then include identifying whether there are documented procedure(s) for each of the identified factors at 110. Generally, it will be understood that the factors listed above are example factors, and in some embodiments the MI may be based on only a subset of the factors listed above. In some embodiments, the MI may be based on additional factors that are not listed above. Therefore, at 110, documented procedures may be identified for the factors identified at 105, whether the factors that are being used for this particular MI calculation are all of the factors listed above, a subset of those factors, or include factors that are not listed above. Additionally, as used herein, the term “guidelines” with respect to element 110 refers to documented accessible procedures. In some embodiments, the “guidelines” may also be referred to as “guidelines,” “controls,” “reference material,” “written material,” etc., or some other term used above with respect to description of the various factors. Identification of the guidelines may be performed by one or more processors of one or more electronic devices based on, for example, operator input, pre-identified data (e.g., data input into the system during a configuration setup), data identified during the course of performing the technique 100 (e.g., mining one or more databases), or some other input.

The technique 100 then includes identifying, at 115, a normalized score for each of the factors identified at 105. Specifically, for each of the factors identified at 105, the procedure(s) identified at 110 may be compared against each of the following scoring criteria: “Policies & Procedures,” “Implementation,” “Monitoring,” and “Continuous Improvements.” “Policies & Procedures” refers to whether an organization has a documented policy or procedure related to the factor that is readily available for consultation by process stakeholders. “Implementation” refers to whether the factor has been consistently implemented on all projects executing within the organization/department/company/team/etc. which is running the procurement process. “Monitoring” refers to whether the organization/department/company/team/etc. has documented performance measure(s) for the given factor, as well as performance targets, and a methodology for collecting best practices and improvement opportunities. “Continuous Improvements” refers to whether the organization/department/company/team/etc. regularly adjusts the implementation of the factor based on identified best practices and improvement opportunities, has a training program for resources that execute the process, and updates process targets based on past results.

Each is then given a normalized score between 0-4, receiving 1 point for each of the scoring criteria that the factor satisfies. For example, if a factor fulfills the requirements of “Policies & Procedures”, “Implementation”, and “Monitoring”, but not “Continuous Improvements”, the assessed score will be 3.

An overall score may then be identified at 120 (e.g., by a processor as described above). In some embodiments, the overall score may be an average of the scores of each of the factors, while in other embodiments certain factors may be weighted more strongly, the score may be a mean or median score, or calculated in accordance with some other type of function.

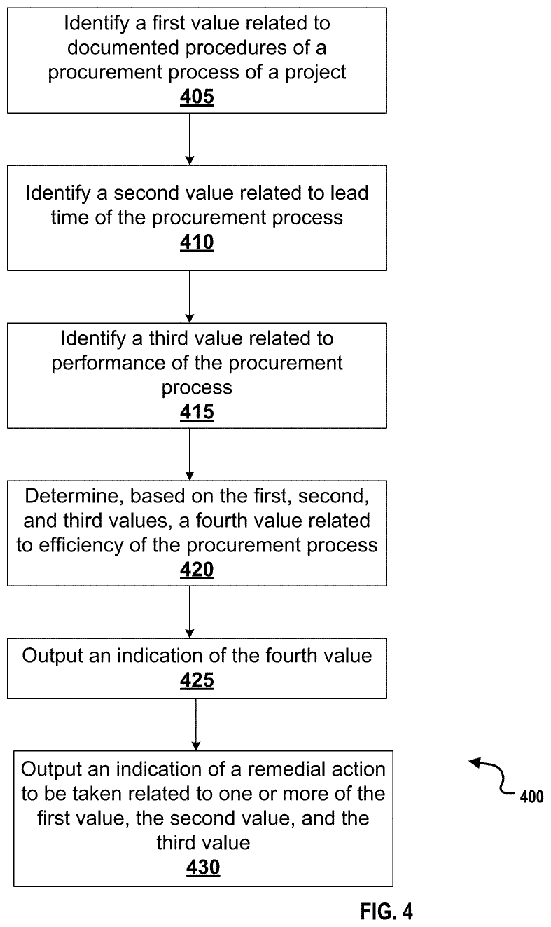

The score may then be output at 125. More specifically, the score for the MI may be output to enable the generation of an overall score for the procurement process, as will be described in greater detail below with respect to FIG. 4. Additionally, the output of the system may include scores related to each process or factor that went into the MI score, as well as an indication of which scores may be improved, and how. Specifically, the system may identify one or more remedial actions which may be taken to improve the scores related to the MI score, or the scores of one or more of the factors on which the MI score is based, and output an indication of the one or more actions.

### LI

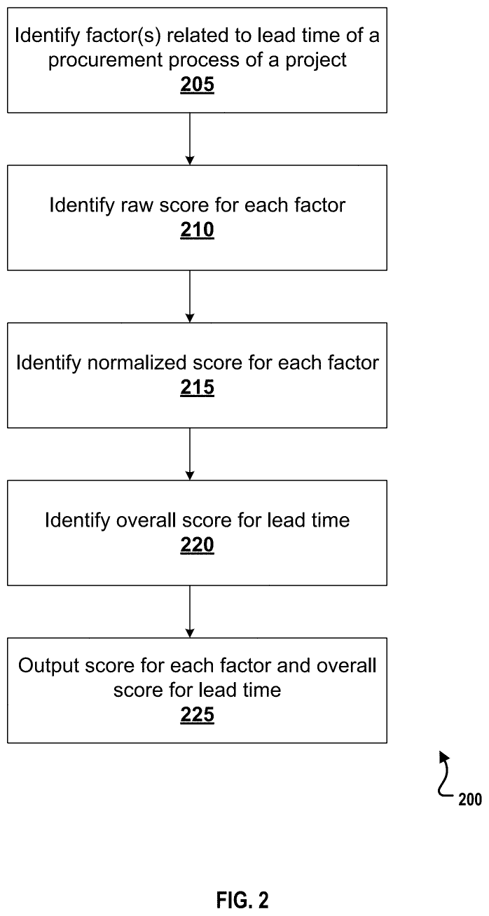

FIG. 2 depicts an example technique 200 by which aspects of the LI may be identified and evaluated, in accordance with various embodiments of the present disclosure. As previously noted, the LI may relate to ongoing material procurement activities on areas where potential impacts may be developing. Therefore, analysis of the LI may allow for the proactive development of mitigation strategies to address delays before the delays affect the progress of the overall project. More generally, the LI allows for tracking over the course of a project, and focuses on different indicators associated with the various stages of the project.

As described with respect to technique 100, technique 200 may be performed by one or more processors of one or more electronic devices based on, for example, operator input, pre-identified data (e.g., data input into the system during a configuration setup), data identified during the course of running the program (e.g., mining one or more databases), or some other input.

The technique may include identifying, at 205, one or more factors related to a lead time of a procurement process of a project. The technique further includes identifying, at 210, a raw score for each factor, and then identifying, at 215, a normalized score for each factor. Similarly to element 120, an overall score for the LI may be identified at 220. This overall score may be based on an average, a mean, a median, one or more weighted factors, etc.

The overall score, as well as the scores for each factor, may then be output at 225 in a manner similar to that described above with respect to element 125. For example, the output of the system may include scores related to each factor that went into the LI score, as well as an indication of which scores may be improved, and how. Specifically, the system may identify one or more remedial actions which may be taken to improve the scores related to the LI score, or the scores of one or more of the factors on which the LI score is based, and output an indication of the one or more actions.

Example factors which may be considered are “Long Lead Material Identification,” “Exceptional Material Procurement Approvals,” “Material Variance,” “Delivery Margin,” “Bidding Duration,” and “Preliminary Design Approval Duration.” Similarly to the MI described above, each of these factors may be used for calculation of a LI, or in other embodiments only a subset of these factors may be used. In some embodiments, the LI may be calculated based on one or more factors that are not listed here. Generally, the listed factors, and scoring criteria thereof, are described herein as examples of one embodiment. The various factors and scoring related to technique 200 are described below:

### Long Lead Material Identification

Generally, this factor may be calculated based on the number of long lead material items related to the project that are planned to arrive at least one month prior to the required at site (RAS) date, divided by the total number of long lead material items identified for the project. This calculation may be expressed as a percentage, which may represent the raw score for this factor.

As used herein, a “long lead material” may refer to a material tag that is required to be purchased during the planning stage or the engineering phase of execution of the project to meet project schedule requirements. The “RAS date” may refer to the date a material tag is required to be at the project site or warehouse in order to meet project schedule requirements. A “material tag” may refer to a unique piece of material which is assigned a specific number and treated individually for tracking purposes.

Based on the raw score identified above, a normalized score between 0 and 4 may be identified (e.g., at element 215). Example normalized scoring is depicted in Table 1, below:

TABLE 1
Normalized Long Lead Material Scoring
Normalized Long Lead Material Scoring

| | |
|---|---|
| 0 | <50% of all long lead items are planned to arrive 1 month prior to their RAS |
| 1 | ≥50% and <60% of all long lead items are planned to arrive 1 month prior to their RAS |
| | or ≥60% of all long lead material are planned to arrive 1 month prior and at least one |
| | long lead material on the critical path is planned to arrive past their RAS |
| 2 | ≥60% and <75% of all long lead items are planned to arrive 1 month prior to their RAS, |
| | no critical path long lead material planned to arrive past their RAS |
| 3 | ≥75% and <90% of all long lead items are planned to arrive 1 month prior to their RAS, |
| | no critical path long lead material planned to arrive past their RAS |
| 4 | ≥90% of all long lead items are planned to arrive 1 month prior to their RAS, no critical |
| | path long lead material planned to arrive past their RAS |

In some embodiments, if any long lead material on the critical path is planned to arrive past its RAS, then the normalized score for this factor may be 0 or 1. As used herein, “critical path material” may refer to a material with a low degree of float or flexibility in timing such that a delay in the material would cause a delay in the overall project schedule. If the secondary condition described above such that greater than or equal to 60% of all long lead material are planned to arrive 1 month prior and at least one long lead material on the critical path is planned to arrive past their RAS, then the score would be no greater than 1 even if other factors indicate a higher score (e.g., a score of 2, 3, or 4 as described above). Additionally, it will be understood that in some embodiments this factor may be assessed between the beginning of the planning stage of the project and completion of execution of the project. Prior to the planning stage, this factor may be reported as “not assessable.”

### Exceptional Material Procurement Approvals

Generally, this factor may be calculated based on the number exceptional material procurement approvals related to the project that were received prior to completion of the planning stage of the project, divided by the total number of exceptional material procurement approvals identified for the project. This calculation may be expressed as a percentage, which may represent the raw score for this factor.

As used herein, an “exceptional material procurement approval” may refer to any material related approval that is required to be provided to the PMT by an organization outside of the project prior to the execution stage. In some embodiments, this factor may be vary between different companies, or between different projects.

Based on the raw score identified above, a normalized score between 0 and 4 may be identified (e.g., at element 215). Example normalized scoring is depicted in Table 2, below:

TABLE 2
Normalized Exceptional Material Procurement Material Scoring
Normalized Exceptional Material Procurement Material Scoring

| | |
|---|---|
| 0 | <70% of all exceptional material procurement approvals received prior to the |
| | execution stage of the project |
| 1 | ≥70% and <80% of all exceptional material procurement approvals received prior to |
| | the execution stage of the project |
| 2 | ≥80% and <90% of all exceptional material procurement approvals received prior to |
| | the execution stage of the project |
| 3 | ≥90% and <100% of all exceptional material procurement approvals received prior to |
| | the execution stage of the project |
| 4 | 100% of all exceptional material procurement approvals received prior to the |
| | execution stage of the project |

In some embodiments, this factor may be assessed between the beginning of the planning stage of the project and completion of execution of the project. Prior to the planning stage, this factor may be reported as “not assessable.”

### Material Variance

Generally, this factor may be calculated based on the number of material tags related to the project that are identified prior to execution of the project, divided by the total number of material tags identified for the project. This calculation may be expressed as a percentage, which may represent the raw score for this factor. Based on this raw score, a normalized score between 0 and 4 may be identified (e.g., at element 215). Example normalized scoring is depicted in Table 3, below:

TABLE 3
Normalized Material Variance Scoring
Normalized Material Variance Scoring

| | |
|---|---|
| 0 | <80% of all material tags are identified prior to the execution stage of the project |
| 1 | ≥80% and <85% of all material tags are identified prior to execution stage of the |
| | project |
| 2 | ≥85% and <90% of all material tags are identified prior to the execution stage of the |
| | project or ≥90% of all material tags are identified prior to execution stage and at |
| | least one material tag is identified during the procurement phase of the execution |
| | stage and is not procured through an active procurement instrument |
| 3 | ≥90% and <95% of all material tags are identified prior to the execution stage of the |
| | project, none during the procurement phase of the execution stage that are not |
| | procured through an active procurement instrument |
| 4 | ≥95% of all material tags are identified prior to the execution stage of the project, |
| | none during the procurement phase of the execution stage that are not procured |
| | through an active procurement instrument |

In some embodiments, if any material tag identified during the procurement phase of the execution stage of the project is not procured through an active procurement instrument, then the score for this factor may be between 0 and 2. Specifically, if greater than or equal to 90% of all material tags are identified prior to execution stage and at least one material tag is identified during the procurement phase of the execution stage and is not procured through an active procurement instrument, then this score may be no greater than 2, even if other factors which may indicate a score of 3 or 4 are present. Additionally, in some embodiments this factor may be assessed during the execution stage of the project. Prior to the execution stage, this factor may be reported as “not assessable.”

### Delivery Margin

Generally, this factor may be calculated based on the number of material tags related to the project that are planned to arrive at least one week prior to their RAS date, divided by the total number of material tags identified for the project. Based on this raw score, a normalized score between 0 and 4 may be identified (e.g., at element 215). Example normalized scoring is depicted in Table 4, below:

TABLE 4
Normalized Delivery Margin Scoring
Normalized Delivery Margin Scoring

| | |
|---|---|
| 0 | <50% of all material tags are planned to arrive 1 week prior to their RAS |
| 1 | ≥50% and <60% of all material tags are planned to arrive 1 week prior to their RAS |
| 2 | ≥60% and <75% of all material tags are planned to arrive 1 week prior to their RAS or |
| | ≥75% of all material tags are planned to arrive 1 week prior to their RAS and 10% or |
| | more of the total number of material tags are planned to arrive after their RAS |
| 3 | ≥75% and <90% of all material tags are planned to arrive 1 week prior to their RAS, |
| | less than 10% are planned to arrive after their RAS |
| 4 | ≥90% of all material tags are planned to arrive 1 week prior to their RAS, less than |
| | 10% are planned to arrive after their RAS |

In some embodiments, if at least 10% of the total number of material tags are planned to arrive after their RAS date, then the score for this factor may be between 0 and 2. Specifically, if greater than or equal to 75% of all material tags are planned to arrive 1 week prior to their RAS and 10% or more of the total number of material tags are planned to arrive after their RAS, then the score may be no higher than 2, even if other factors may indicate a score of 3 or 4 for this factor. Additionally, in some embodiments this factor may be assessed during the execution stage of the project. Prior to the execution stage, this factor may be reported as “not assessable.”

### Bidding Duration

Generally, this factor may be calculated based on the number of material tags related to the project that have a bidding duration of four weeks or less, divided by the total number of material tags related to the project that have completed bidding. As used herein, “bidding duration” refers to the difference between the initial request for quotation (RFQ) issue date, and the final bid closing date.

Based on this raw score, a normalized score between 0 and 4 may be identified (e.g., at element 215). Example normalized scoring is depicted in Table 5, below:

TABLE 5
Normalized Bidding Duration Scoring
Normalized Bidding Duration Scoring

| | |
|---|---|
| 0 | <60% of all material tags have a bidding duration of 4 weeks or less |
| 1 | ≥60% and <75% of all material tags have a bidding duration of 4 weeks or less |
| 2 | ≥75% and <90% of all material tags have a bidding duration of 4 weeks or less or ≥90% |
| | of all material tags have a bidding duration of 4 weeks or less and at least one |
| | material tag has a bidding duration greater than 6 weeks and the purchase instrument |
| | has not been issued |
| 3 | ≥90% and <95% of all material tags have a bidding duration of 4 weeks or less, none |
| | greater than 6 weeks without an issued purchase instrument |
| 4 | 95% of all material tags have a bidding duration of 4 weeks or less, none greater than |
| | 6 weeks without an issued purchase instrument |

In some embodiments if any material tags have a bidding duration greater than 6 weeks, and the purchase instrument has not been issued, then the score for this factor may be between 0 and 2. Specifically, if greater than or equal to 90% of all material tags have a bidding duration of 4 weeks or less, and at least one material tag has a bidding duration greater than 6 weeks and the purchase instrument has not been issued, then the normalized score may be no greater than 2 regardless of whether other factors indicate a score of 3 or 4. Additionally, in some embodiments this factor may be assessed during the execution stage of the project. Prior to the execution stage, this factor may be reported as “not assessable.”

### Preliminary Design Approval Duration

Generally, this factor may be calculated based on the number of material tags related to the project that have a preliminary design approval duration of less than four weeks, divided by the total number of material tags related to the project with a preliminary design approval submitted to the PMT for approval by the time of the assessment. As used herein, “preliminary design approval duration” refers to the difference between the date that the final complete preliminary design document is submitted to the PMT, and the PMT's approval date.

Based on this raw score, a normalized score between 0 and 4 may be identified (e.g., at element 215). Example normalized scoring is depicted in Table 6, below:

TABLE 6
Normalized Preliminary Design Approval Duration Scoring
Normalized Preliminary Design Approval Duration Scoring

| | |
|---|---|
| 0 | <60% of all material tags have a preliminary design approval duration of less than 4 Weeks |
| 1 | ≥60% and <70% of all material tags have a preliminary design approval duration of |
| | less than 4 Weeks |
| 2 | ≥70% and <80% of all material tags have a preliminary design approval duration of |
| | less than 4 Weeks or ≥80% of all material tags have a preliminary design approval |
| | duration of less than 4 Weeks and at least 10% of all material tags have a preliminary |
| | design approval duration greater than 6 weeks |
| 3 | ≥80% and <90% of all material tags have a preliminary design approval duration of |
| | less than 4 Weeks, with less than 10% greater than 6 weeks |
| 4 | ≥90% of all material tags have a preliminary design approval duration of less than 4 |
| | Weeks, with less than 10% greater than 6 weeks |

In some embodiments if 10% of the material tags have a preliminary design approval duration greater than six weeks, then the score for this factor may be between 0 and 2. Specifically, if greater than or equal to 80% of all material tags have a preliminary design approval duration of less than four weeks, and at least 10% of all material tags have a preliminary design approval duration greater than six weeks, then the normalized score for this factor may be no greater than 2 regardless of whether other factors would indicate a score of 3 or 4. Additionally, in some embodiments this factor may be assessed during the execution stage of the project. Prior to the execution stage, this factor may be reported as “not assessable.”

### PI

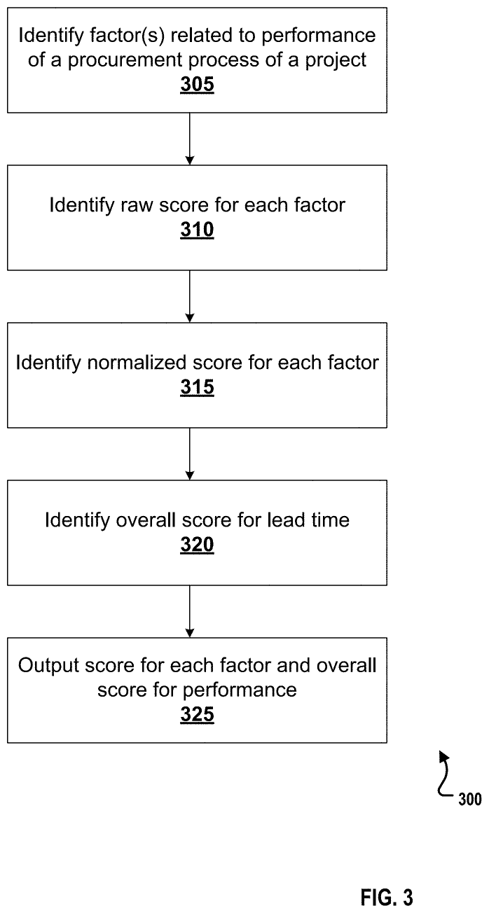

FIG. 3 depicts an example technique 300 by which aspects of the PI may be identified and evaluated, in accordance with various embodiments of the present disclosure. As previously noted, the PI may relate to actual performance of material procurement activities on a given project. Specifically, the PI may be based on one or more factors that set the basis for identifying opportunities to improve procurement effectiveness, and close performance gaps.

As described with respect to technique 200, technique 300 may be performed by one or more processors of one or more electronic devices based on, for example, operator input, pre-identified data (e.g., data input into the system during a configuration setup), data identified during the course of running the program (e.g., mining one or more databases), or some other input.

The technique may include identifying, at 305, one or more factors related to a performance of a procurement process of a project. The technique further includes identifying, at 310, a raw score for each factor, and then identifying, at 315, a normalized score for each factor. Similarly to elements 120 or 220, an overall score for the PI may be identified at 320. This overall score may be based on an average, a mean, a median, one or more weighted factors, etc.

The overall score, as well as the scores for each factor, may then be output at 325 in a manner similar to that described above with respect to elements 125 or 225. For example, the output of the system may include scores related to each factor that went into the PI score, as well as an indication of which scores may be improved, and how. Specifically, the system may identify one or more remedial actions which may be taken to improve the scores related to the PI score, or the scores of one or more of the factors on which the PI score is based, and output an indication of the one or more actions.

Example factors which may be considered are “Procurement Cycle,” “On-Time Delivery,” “Inventory Utilization,” “Localization,” “Bidders List Healthiness,” and “Material Quality.” Similarly to the MI or LI described above, each of these factors may be used for calculation of a PI, or in other embodiments only a subset of these factors may be used. In some embodiments, the PI may be calculated based on one or more factors that are not listed here. Generally, the listed factors, and scoring criteria thereof, are described herein as examples of one embodiment. The various factors and scoring related to technique 300 are described below:

### Procurement Cycle

Generally, this factor may be calculated based on the average procurement cycle of all material tags with issued purchase orders for the project. As used herein, the term “procurement cycle” may refer to the difference between the purchase order release date and the PR approval date.

Based on this raw score, a normalized score between 0 and 4 may be identified (e.g., at element 315). Example normalized scoring is depicted in Table 7, below:

TABLE 7
Normalized Procurement Cycle Scoring
Normalized Procurement Cycle Scoring

| | |
|---|---|
| 0 | Procurement Cycle >158 days |
| 1 | Procurement Cycle >138 and ≤158 days |
| 2 | Procurement Cycle >118 and ≤138 days |
| 3 | Procurement Cycle >98 and ≤118 days |
| 4 | Procurement Cycle ≤98 days |

In some embodiments, this factor may be assessed during the execution stage of the project. Prior to the execution stage, this factor may be reported as “not assessable.”

### On-Time Delivery

Generally, this factor may be calculated based on the average on-time delivery of all delivered material tags for the project. As used herein, the term “on-time delivery” may refer to a situation in which the actual delivery date of the material is less than or equal to the contractual delivery date for that material. The “actual delivery date” may refer to the date of the material arriving at the delivery location, and the “contractual delivery date” may refer to the delivery date listed on the issued purchase instrument (or the date from the formally issued change order) related to the material.

Based on this raw score, a normalized score between 0 and 4 may be identified (e.g., at element 315). Example normalized scoring is depicted in Table 8, below:

TABLE 8
Normalized On-Time Delivery Scoring
Normalized On-Time Delivery Scoring

| | |
|---|---|
| 0 | On-Time Delivery <50% |
| 1 | On-Time Delivery ≥50% and <70% |
| 2 | On-Time Delivery ≥70% and <80% |
| 3 | On-Time Delivery ≥80% and <90% |
| 4 | On-Time Delivery ≥90% |

In some embodiments, this factor may be assessed during the execution stage of the project. Prior to the execution stage, this factor may be reported as “not assessable.”

### Inventory Utilization

Generally, this factor may be calculated based on the value of material supplied from inventory for the project (surplus and excess stock) divided by the sum of the value of material supplied from inventory for the project (surplus and excess stock) plus the value of all material to be purchased for the project.

Based on this raw score, a normalized score between 0 and 4 may be identified (e.g., at element 315). Example normalized scoring is depicted in Table 9, below:

TABLE 9
Normalized Inventory Utilization Scoring
Normalized Inventory Utilization Scoring

| | |
|---|---|
| 0 | Not applicable for scoring |
| 1 | Inventory Utilization ≥0% and <0.5% |
| 2 | Inventory Utilization ≥0.5% and <2% |
| 3 | Inventory Utilization ≥2% and <3% |
| 4 | Inventory Utilization ≥3% |

In some embodiments, this factor may be assessed during the execution stage of the project. Prior to the execution stage, this factor may be reported as “not assessable.”

### Localization

Generally, this factor may be calculated based on the value of all material tags purchased from a local manufacturer on a project, divided by the value of all material tags with issued purchase orders on the project. As used herein, a “local manufacturer” refers to a supplier that manufactures the material tag in the same country of the procuring organization/team/company/PMT/etc.

Based on this raw score, a normalized score between 0 and 4 may be identified (e.g., at element 315). Example normalized scoring is depicted in Table 10, below:

TABLE 10
Normalized Localization Scoring
Normalized Localization Scoring

| | |
|---|---|
| 0 | Localization <20% |
| 1 | Localization ≥20% and <30% |
| 2 | Localization ≥30% and <40% |
| 3 | Localization ≥40% and <50% |
| 4 | Localization ≥50% |

In some embodiments, this factor may be assessed during the execution stage of the project. Prior to the execution stage, this factor may be reported as “not assessable.”

### Bidders List Healthiness

Generally, this factor may be calculated based on the average number of bidders on an approved bidders list for material tags on the project. Based on this raw score, a normalized score between 0 and 4 may be identified (e.g., at element 315). Example normalized scoring is depicted in Table 11, below:

TABLE 11
Normalized Bidders List Healthiness Scoring
Normalized Bidders List Healthiness Scoring

| | |
|---|---|
| 0 | Bidders List Healthiness <2.5 |
| 1 | Bidders List Healthiness ≥2.5 and <3 |
| 2 | Bidders List Healthiness ≥3 and <3.5 |
| 3 | Bidders List Healthiness ≥3.5 and <4 |
| 4 | Bidders List Healthiness ≥4 |

In some embodiments, this factor may be assessed during the execution stage of the project. Prior to the execution stage, this factor may be reported as “not assessable.”

### Material Quality

Generally, this factor may be calculated based on the number of material tags received without a documented nonconformity on a project, divided by the total number of material tags received on the project. As used herein, the term “documented nonconformity” may refer to a documented observation of a material tag not meeting the contractual material specification or requirements.

Based on this raw score, a normalized score between 0 and 4 may be identified (e.g., at element 315). Example normalized scoring is depicted in Table 12, below:

TABLE 12
Normalized Material Quality Scoring
Normalized Material Quality Scoring

| | |
|---|---|
| 0 | Material Quality ≤92% |
| 1 | Material Quality >92% and ≤94% |
| 2 | Material Quality >94% and ≤96% |
| 3 | Material Quality >96% and ≤98% |
| 4 | Material Quality >98% |

In some embodiments, this factor may be assessed during the execution stage of the project. Prior to the execution stage, this factor may be reported as “not assessable.”

### Overall Score

FIG. 4 depicts an example technique 400 by which a score related to the efficiency of the procurement process may be identified and evaluated, in accordance with various embodiments of the present disclosure. Similarly to other techniques described herein with respect to FIG. 1, 2, or 3, it will be understood that the technique 400 of FIG. 4 is intended as one example embodiment. Other embodiments may include more or fewer elements or factors than are depicted in FIG. 4, elements in a different order than depicted (e.g., the order of two elements may be reversed or certain elements may occur concurrently). Other variations may be present.

The technique may include identifying, at 405, a first value related to documented procedures of a procurement process of a project. This first value may be, for example, the overall MI score output at 125.

The technique 400 may further include identifying, at 410, a second value related to lead time of the procurement process. This second value may be, for example, the overall LI score output at 225.

The technique 400 may further include identifying, at 415, a third value related to performance of the procurement process. This third value may be, for example, the overall LI score output at 325.

The technique 400 may further include determining, at 420, based on the first, second, and third values (respectively identified at 405, 410, and 415), a fourth value related to efficiency of the procurement process. This fourth value may be, for example, an average of the first, second, and third values. In other embodiments, this fourth value may be a mean value, a median value, weighted such that one of the first, second, or third values affects the overall value more than another, a sum, etc. Generally, the particular function used to identify the overall value at 420 may be based on the specific project, a preference of the company/team/organization/etc. that is performing the analysis, or some other factor.

The technique 400 may further include outputting, at 425, an indication of the fourth value. In some embodiments, only the fourth (e.g., the overall) value may be output. In other embodiments, the outputting may include outputting an indication of one or more of the first, second, and third values. In some embodiments, the outputting may further include outputting an indication of a score of one or more of the factors that were used to identify one or more of the first, second, or third values.

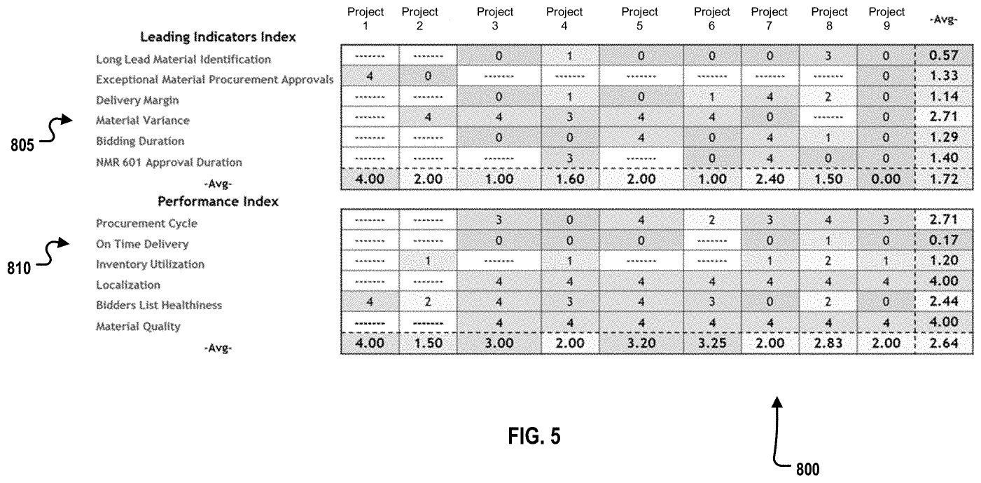

FIG. 5 depicts an example 800 of such an output. Specifically, FIG. 5 depicts an example output of both a LI 805 for nine projects (e.g., as calculated in accordance with FIG. 2) and a PI 810 for the nine projects (e.g., as calculated in accordance with FIG. 3). The output shows, for example, the normalized scores for each factor that was used to calculate the overall LI 805 and PI 810 scores.

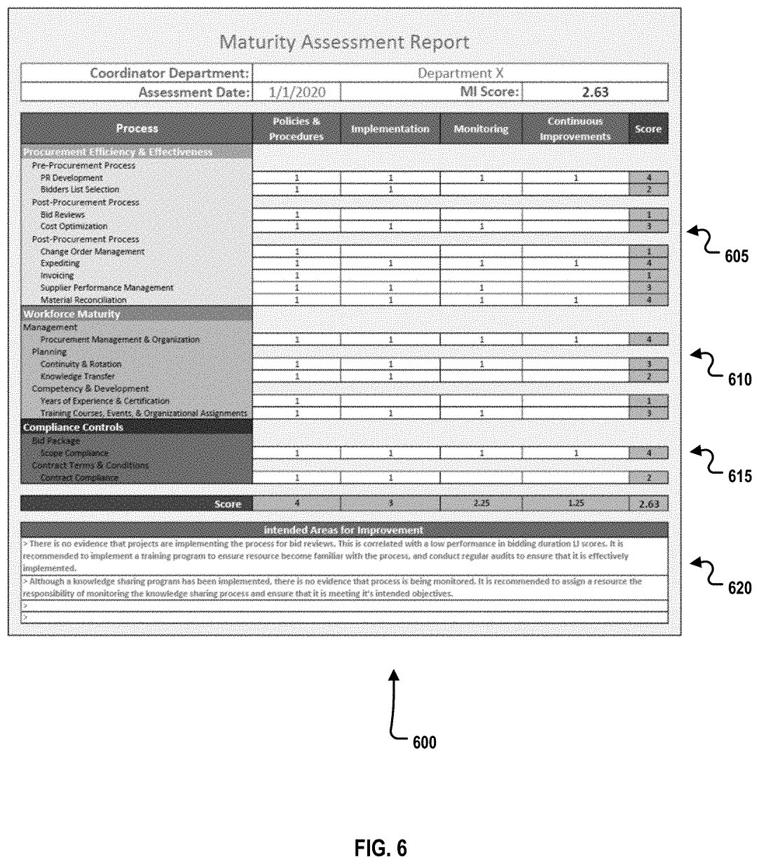

FIG. 6 depicts an alternative example 600 output of the analysis of the procurement process, in accordance with various embodiments. Specifically, FIG. 6 depicts an example output 600 related to a MI. The output 600 may include, for example, factors 605 related to Procurement Efficiency and Effectiveness at 605, Workforce Maturity at 610, and Compliance Controls 615, which are similar to the factors described above with respect to the MI factors. As may be seen, and as will be described below with respect to element 430, the output 600 may include indications at 620 related to potential areas for improvement. These areas for improvement may be changes or corrective actions which may be made to increase or other improve one or more of the scores depicted in the output 600. How the actions are identified, and what they may be, are described in further detail below with respect to element 430.

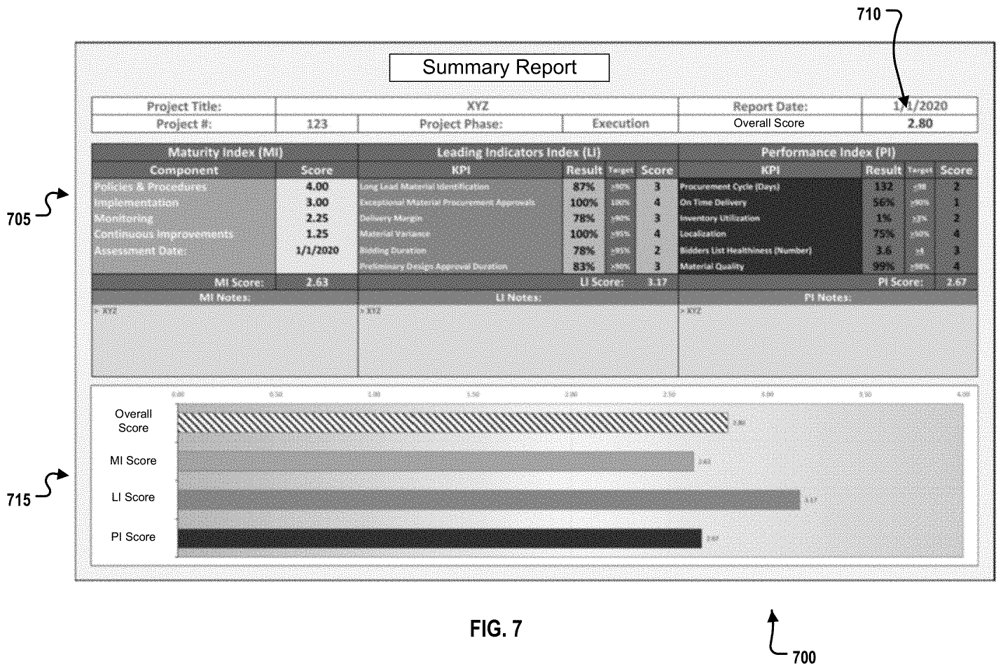

FIG. 7 depicts an alternative example output 700 of the analysis of the procurement process, in accordance with various embodiments. As may be seen, the output 700 may include one or more scores 705 related to each of the MI, LI, and PI as described above. In some embodiments, the scores may include the raw results (e.g., as may be seen with respect to the LI and the PI) in addition to the normalized scoring, or the scores may only include the normalized scoring (e.g., as may be seen with respect to the MI). In this embodiment, the output 700 may further include an overall score as may be seen at 710. As noted above, the overall score may relate to an averaging of the scores of the MI, LI, and PI, or may be based on some other function. The output 700 may further include a graphical depiction of the various scores at 715.

Generally, it will be recognized that the outputs 800, 600, and 700 of FIGS. 5, 6, and 7 are intended as examples of such an output, and other embodiments may vary. For example, the specific information included, the arrangement of such information, etc. may be different in different embodiments.

In some embodiments, the technique 400 may further include outputting, at 430, an indication of a remedial action that is to be taken related to one or more of the first value, the second value, and the third value. Specifically, the processor(s) performing the technique of FIG. 4 may analysis one or more of the scores of the MI, LI, PI, or overall score, and, optionally, one or more of the factors that contributed to those scores. The processor may then identify corrective actions associated with low performance, and output an indication of such corrective actions. Such corrective actions may be related to a specific project that is currently being undertaken and may include, for example expediting material, reducing bidding durations, etc. By performing these corrective actions, the score of one or more factors may be increased, thereby increasing the scores of one or more of the MI, LI, PI, and overall score. In addition to these project-specific actions, the processor may identify areas of improvement in the supporting processes and procedures of the executing organization to increase such scores at an organizational, rather than project, level.

Described implementations of the subject matter can include one or more features, alone or in combination.

For example, in a first implementation, one or more non-transitory computer-readable media include instructions that, upon execution of the instructions by one or more processors of an electronic device, are to cause the electronic device to: identify a first value related to documented procedures of a procurement process of a project; identify a second value related to lead time of the procurement process; identify a third value related to performance of the procurement process; determine, based on the first, second, and third values, a fourth value related to efficiency of the procurement process; and output an indication of the fourth value.

The foregoing and other described implementations can each, optionally, include one or more of the following features:

In a first feature, combinable with one or more of the other features described herein, the instructions are further to output at least one of the first value, the second value, and the third value.

In a second feature, combinable with one or more of the other features described herein, the instructions are further to output an indication of a remedial action to be taken related to one or more of the first value, the second value, and the third value.

In a third feature, combinable with one or more of the other features described herein, the instructions are further to identify the first value based on comparison of one or more factors related to the documented procedures to pre-identified scoring criteria.

In a fourth feature, combinable with one or more of the other features described herein, the instructions are further to output an indication of application of the scoring criteria to respective ones of the one or more factors related to the documented procedures.

In a fifth feature, combinable with one or more of the other features described herein, the instructions are further to identify the second value based on comparison of one or more factors related to the lead time of the procurement process to pre-identified scoring criteria.

In a sixth feature, combinable with one or more of the other features described herein, the pre-identified scoring criteria applied to one of the one or more factors is different than the pre-identified scoring criteria applied to another of the one or more factors.

In a seventh feature, combinable with one or more of the other features described herein, the instructions are further to output an indication of a result of application of the pre-identified scoring criteria to a factor of the one or more factors.

In an eighth feature, combinable with one or more of the other features described herein, the instructions are further to identify the third value based on comparison of one or more factors related to the performance of the procurement process to pre-identified scoring criteria.

In a ninth feature, combinable with one or more of the other features described herein, the pre-identified scoring criteria applied to one of the one or more factors is different than the pre-identified scoring criteria applied to another of the one or more factors.

In a tenth feature, combinable with one or more of the other features described herein, the instructions are further to output an indication of a result of application of the pre-identified scoring criteria to a factor of the one or more factors.

A second implementation is a method that includes: averaging, by one or more processors of an electronic device, normalized values related to a first plurality of factors to generate a first value related to documented procedures of a procurement process of a project; averaging, by the one or more processors, normalized values related to a second plurality of factors to generate a second value related to lead time of the procurement process; averaging, by the one or more processors, normalized values related to a third plurality of factors to generate a third value related to performance of the procurement process; determining, by the one or more processors based on the first, second, and third values, a fourth value related to efficiency of the procurement process; outputting, by the one or more processors, an indication of the fourth value; and outputting, by the one or more processors, an indication of a remedial action to be taken related to one or more of the first value, the second value, and the third value.

The foregoing and other described implementations can each, optionally, include one or more of the following features:

In a first feature, combinable with one or more other features described herein, the method further includes outputting, by the one or more processors, at least one of the first value, the second value, and the third value.

In a second feature, combinable with one or more other features described herein, the method further includes identifying, by the one or more processors, the normalized values related to the first plurality of factors based on comparison of respective ones of the first plurality of factors to pre-identified scoring criteria.

In a third feature, combinable with one or more other features described herein, the method further includes outputting, by the one or more processors, an indication of one or more of the normalized values related to the first plurality of factors.

In a fourth feature, combinable with one or more other features described herein, the method further includes identifying, by the one or more processors, the normalized values related to the second plurality of factors based on comparison of respective ones of the second plurality of factors to pre-identified scoring criteria.

In a fifth feature, combinable with one or more other features described herein, the pre-identified scoring criteria applied to one of the second plurality of factors is different than the pre-identified scoring criteria applied to another of the second plurality of factors.

In a sixth feature, combinable with one or more other features described herein, the method further includes outputting, by the one or more processors, an indication of one or more of the normalized values related to the second plurality of factors.

In a seventh feature, combinable with one or more other features described herein, the method further includes identifying, by the one or more processors, the normalized values related to the third plurality of factors based on comparison of respective ones of the third plurality of factors to pre-identified scoring criteria.

In an eighth feature, combinable with one or more other features described herein, the pre-identified scoring criteria applied to one of the third plurality of factors is different than the pre-identified scoring criteria applied to another of the third plurality of factors.

In a ninth feature, combinable with one or more other features described herein, the method further includes outputting, by the one or more processors, an indication of one or more of the normalized values related to the third plurality of factors.

A third implementation is an electronic device that includes: one or more processors; and one or more non-transitory computer-readable media comprising instructions that, upon execution of the instructions by the one or more processors, are to cause the electronic device to: identify a first value related to documented procedures of a procurement process of a project; identify a second value related to lead time of the procurement process; identify a third value related to performance of the procurement process; determine, based on an average of the first, second, and third values, a fourth value related to efficiency of the procurement process; and output an indication of the fourth value.

The foregoing and other described implementations can each, optionally, include one or more of the following features:

In a first feature, combinable with one or more other features described herein, the instructions are further to output at least one of the first value, the second value, and the third value.

In a second feature, combinable with one or more other features described herein, the instructions are further to output an indication of a remedial action to be taken related to one or more of the first value, the second value, and the third value.

In a third feature, combinable with one or more other features described herein, the instructions are further to identify the first value based on comparison of one or more factors related to the documented procedures to pre-identified scoring criteria.

In a fourth feature, combinable with one or more other features described herein, the instructions are further to output an indication of application of the scoring criteria to respective ones of the one or more factors related to the documented procedures.

In a fifth feature, combinable with one or more other features described herein, the instructions are further to identify the second value based on comparison of one or more factors related to the lead time of the procurement process to pre-identified scoring criteria.

In a sixth feature, combinable with one or more other features described herein, the pre-identified scoring criteria applied to one of the one or more factors is different than the pre-identified scoring criteria applied to another of the one or more factors.

In a seventh feature, combinable with one or more other features described herein, the instructions are further to output an indication of a result of application of the pre-identified scoring criteria to a factor of the one or more factors.

In an eighth feature, combinable with one or more other features described herein, the instructions are further to identify the third value based on comparison of one or more factors related to the performance of the procurement process to pre-identified scoring criteria.

In a ninth feature, combinable with one or more other features described herein, the pre-identified scoring criteria applied to one of the one or more factors is different than the pre-identified scoring criteria applied to another of the one or more factors.

In a tenth feature, combinable with one or more other features described herein, the instructions are further to output an indication of a result of application of the pre-identified scoring criteria to a factor of the one or more factors.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a CPU, a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various Figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term GUI can be used in the singular or the plural to describe one or more GUIs and each of the displays of a particular GUI. Therefore, a GUI can represent any GUI, including, but not limited to, a web browser, a touch-screen, or a command line interface (CLI) that processes information and efficiently presents the information results to the user. In general, a GUI can include a plurality of UI elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. One or more non-transitory computer-readable media comprising instructions that, upon execution of the instructions by one or more processors of an electronic device, are to cause the electronic device to:
identify a first value related to documented procedures of a procurement process of a project;
identify a second value related to lead time of the procurement process;
identify a third value related to performance of the procurement process;
determine, based on the first, second, and third values, a fourth value related to efficiency of the procurement process; and
output an indication of the fourth value.

2. The one or more non-transitory computer-readable media of claim 1, wherein the instructions are further to output at least one of the first value, the second value, and the third value.

3. The one or more non-transitory computer-readable media of claim 1, wherein the instructions are further to output an indication of a remedial action to be taken related to one or more of the first value, the second value, and the third value.

4. The one or more non-transitory computer-readable media of claim 1, wherein the instructions are further to identify the first value based on comparison of one or more factors related to the documented procedures to pre-identified scoring criteria.

5. The one or more non-transitory computer-readable media of claim 4, wherein the instructions are further to output an indication of application of the scoring criteria to respective ones of the one or more factors related to the documented procedures.

6. The one or more non-transitory computer-readable media of claim 1, wherein the instructions are further to identify the second value based on comparison of one or more factors related to the lead time of the procurement process to pre-identified scoring criteria.

7. The one or more non-transitory computer-readable media of claim 1, wherein the instructions are further to identify the third value based on comparison of one or more factors related to the performance of the procurement process to pre-identified scoring criteria.

8. A method comprising:
averaging, by one or more processors of an electronic device, normalized values related to a first plurality of factors to generate a first value related to documented procedures of a procurement process of a project;
averaging, by the one or more processors, normalized values related to a second plurality of factors to generate a second value related to lead time of the procurement process;
averaging, by the one or more processors, normalized values related to a third plurality of factors to generate a third value related to performance of the procurement process;
determining, by the one or more processors based on the first, second, and third values, a fourth value related to efficiency of the procurement process;
outputting, by the one or more processors, an indication of the fourth value; and
outputting, by the one or more processors, an indication of a remedial action to be taken related to one or more of the first value, the second value, and the third value.

9. The method of claim 8, wherein the method further comprises outputting, by the one or more processors, at least one of the first value, the second value, and the third value.

10. The method of claim 8, wherein the method further comprises identifying, by the one or more processors, the normalized values related to the first plurality of factors based on comparison of respective ones of the first plurality of factors to pre-identified scoring criteria.

11. The method of claim 10, wherein the method further comprises outputting, by the one or more processors, an indication of one or more of the normalized values related to the first plurality of factors.

12. The method of claim 8, wherein the method further comprises identifying, by the one or more processors, the normalized values related to the second plurality of factors based on comparison of respective ones of the second plurality of factors to pre-identified scoring criteria.

13. The method of claim 8, wherein the method further comprises identifying, by the one or more processors, the normalized values related to the third plurality of factors based on comparison of respective ones of the third plurality of factors to pre-identified scoring criteria.

14. An electronic device comprising:
one or more processors; and
one or more non-transitory computer-readable media comprising instructions that, upon execution of the instructions by the one or more processors, are to cause the electronic device to:
identify a first value related to documented procedures of a procurement process of a project;
identify a second value related to lead time of the procurement process;
identify a third value related to performance of the procurement process;
determine, based on an average of the first, second, and third values, a fourth value related to efficiency of the procurement process; and
output an indication of the fourth value.

15. The electronic device of claim 14, wherein the instructions are further to identify the second value based on comparison of one or more factors related to the lead time of the procurement process to pre-identified scoring criteria.

16. The electronic device of claim 15, wherein the pre-identified scoring criteria applied to one of the one or more factors is different than the pre-identified scoring criteria applied to another of the one or more factors.

17. The electronic device of claim 15, wherein the instructions are further to output an indication of a result of application of the pre-identified scoring criteria to a factor of the one or more factors.

18. The electronic device of claim 14, wherein the instructions are further to identify the third value based on comparison of one or more factors related to the performance of the procurement process to pre-identified scoring criteria.

19. The electronic device of claim 18, wherein the pre-identified scoring criteria applied to one of the one or more factors is different than the pre-identified scoring criteria applied to another of the one or more factors.

20. The electronic device of claim 18, wherein the instructions are further to output an indication of a result of application of the pre-identified scoring criteria to a factor of the one or more factors.
